(19) United States
(12) Patent Application Publication
(10) Pub. No.: US 2007/0136127 A1
(43) Pub. Date: Jun. 14, 2007

(54) Vehicle parking system

(76) Inventor: Shih-Hsiung Li, Taipei (TW)

Correspondence Address: HERSHKOVITZ & ASSOCIATES, 2845 DUKE STREET, ALEXANDRIA, VA, 22314, US

(21) Appl. No.: 11/297,474

(22) Filed: Dec. 9, 2005

(51) Int. Cl. G07B 15/00

(52) U.S. Cl. 705/13

(57) ABSTRACT

A vehicle parking system has at least one host computer and multiple gate controllers set respectively at an entrance of a corresponding parking space and connected to the host computer. Each gate controller has an auto-restraining and parking fee charging and collection capability. When a vehicle enters a parking space, the gate controller will auto-detect and then start to count parking time. After the driver passes the identification recognition process and then pays the parking fee, the gate controller will allow the driver to drive the vehicle out of the parking space.

### BACKGROUND OF THE INVENTION

1. Field of the Invention

The present invention relates to a vehicle parking system, and more particularly to a vehicle parking system having a high vehicle handling capacity.

2. Description of the Related Art

With reference to FIG. 7, a vehicle parking system (30) with a centralized management system has many vehicle parking spaces (31) and a charge station (40). The charge station (40) is set between an entrance lane (32) and an exit lane (33) and usually has a booth (43), an entrance gate (41) and an exit gate (42).

The entrance gate (41) has a controller (411) and an electrical gate (412) at the entrance lane (32) to control the vehicle flow entering the vehicle parking area (30).

The exit gate (42) has a computer (421) set in the booth (43) and an electrical gate (422) connected to the computer (421). The electrical gate (422) blocks the exit lane (33). The exit gate (42) is used to control vehicles exiting the vehicle parking area (30) in order to collect a parking fee from the vehicle driver.

When a vehicle drives into the entrance lane (32) and approaches the entrance gate (41), the controller (411) will signal the driver to take a ticket with a time of entry. The ticket can be a paper ticket with a printed time of entry, a paper card with a magnetic strip recording the time of entry, or a plastic card with memory recording the time. When the controller (411) detects that the driver has taken the ticket, the controller (411) will open the electrical gate (412) to allow the vehicle to enter the vehicle parking area (30).

When the vehicle driver would like to leave the vehicle parking area, the vehicle will drive into the exit lane (33) and stop at the front of the exit gate (53). At this time, an employee in the booth (43) will take the ticket from the driver of the vehicle and input the time of entry into the computer (421). The computer (421) will calculate the parking fee that the driver should pay. When the employee has finished the charging process, the employee will open the electrical gate (422) to allow the vehicle to leave the vehicle parking area (30).

Since the parking management is a centralized system, the vehicle handling capacity of the system is not good during busy times. Drivers have to spend more time in line to enter or exit the parking area.

Therefore, the present invention provides a new vehicle parking system with a distributed management system to increase the vehicle handling capacity.

### SUMMARY OF THE INVENTION

The main objective of the present invention is to provide a vehicle parking system that has a high vehicle handling capacity.

The vehicle parking system has at least one host computer and multiple gate controllers set respectively at the entrance of a corresponding parking space and connected to the host computer. Each gate controller has an auto-restraining and parking fee charging and collection capability. When a vehicle enters the vehicle entrance of a parking space, the gate controller will auto-detect and then start to count parking time. After the driver passes an identification recognition process and then pays the parking fee, the gate controller will allow the driver to drive vehicle out of the parking space.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a vehicle parking system in accordance with the present invention;

FIG. 2 is a plan view of an arrangement of the vehicle parking system in accordance with the present invention;

FIG. 3 is an operational front view of two gates of the vehicle parking system in accordance of the present invention;

FIG. 4 is a functional block diagram of a controller of the vehicle parking system in accordance with the present invention;

FIG. 5 is a top view of a controller of the vehicle parking system in accordance with the present invention;

FIG. 6 is an operation top view of the vehicle parking system in accordance with the present invention; and

FIG. 7 is a plan view of an arrangement of a conventional vehicle parking system with a centralized management system in accordance with the prior art.

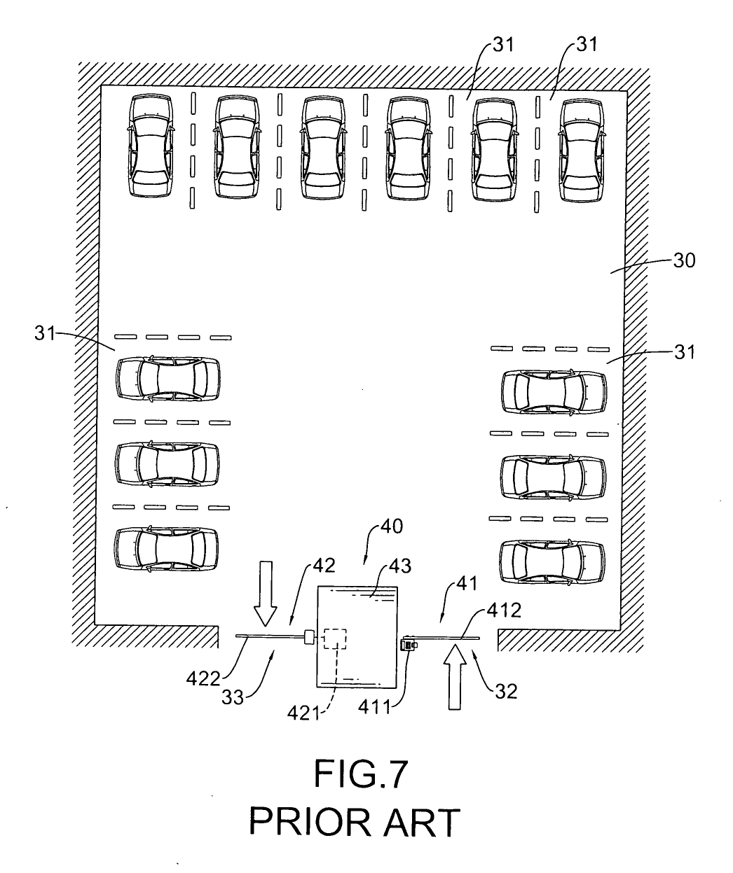

### DETAILED DESCRIPTION OF THE PREFERRED EMBODIMENT

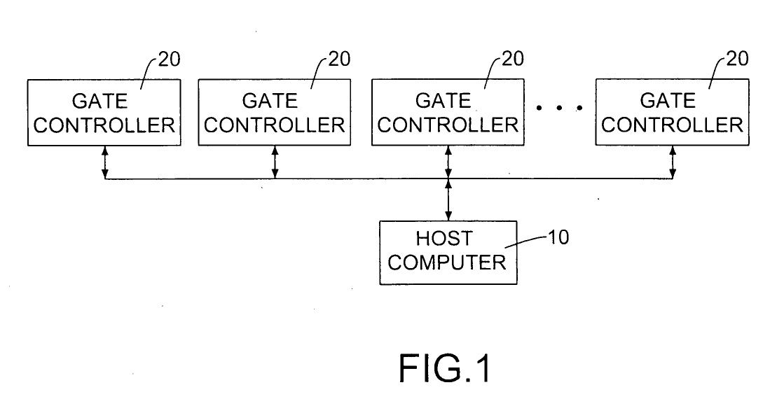

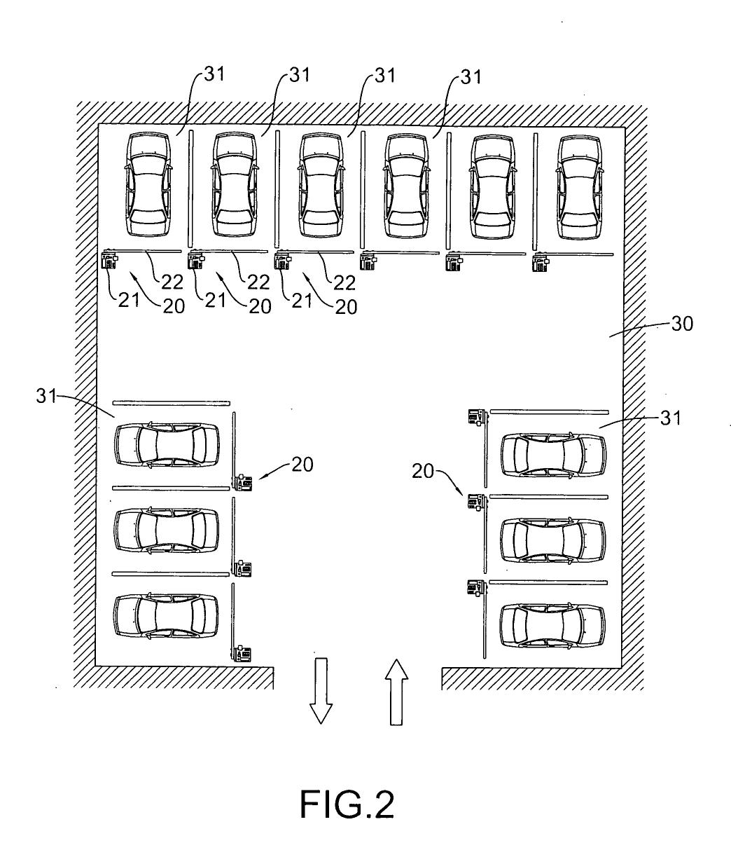

With reference to FIG. 1, a vehicle parking system in accordance with the present invention has a host computer (10) and multiple gate controllers (20). Each gate controller (20) is connected to the host computer (10). With further reference to FIG. 2, there are many parking spaces (31) in a vehicle parking area (30). The gate controllers (20) are set respectively at an entrance of a corresponding parking space (31).

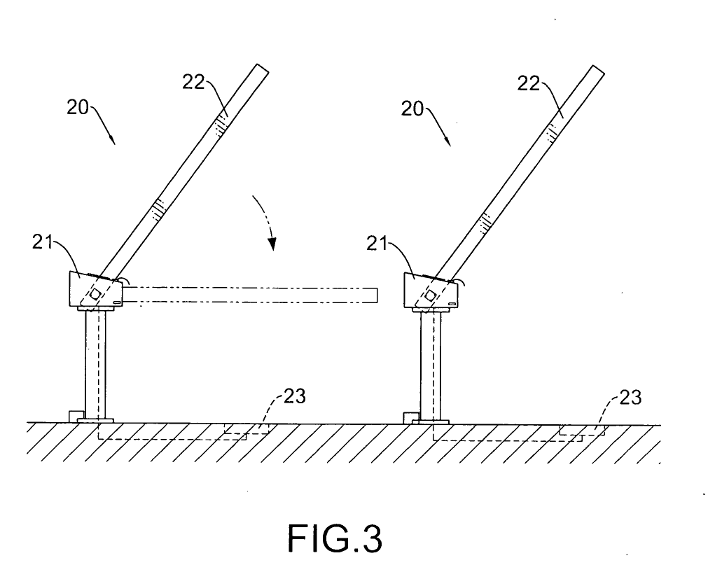

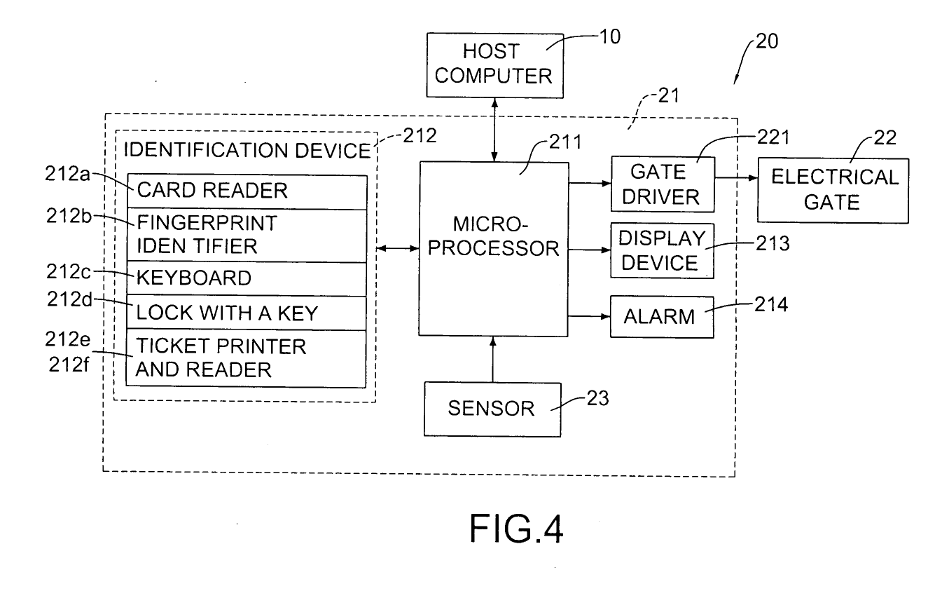

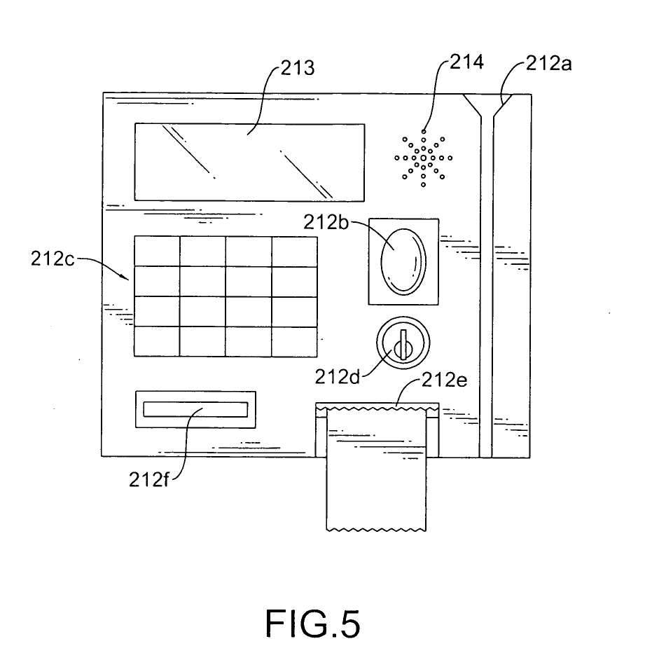

With reference to FIGS. 3, 4 and 5, each gate controller (20) has a main controller (21) and an electrical gate (22) connected to the main controller (21). The main controller (21) has a microprocessor (211), an identification device (212), a gate driver (221), an optional display device (213), an optional alarm (214) and a sensor (23).

The microprocessor (211) has multiple inputs and outputs and is linked to the host computer (10) through wires or wireless communication methods. The microprocessor (211) can report related parking information of the corresponding parking space (31) to the host computer (10), such as parking times or the status of the electric gate (22). The host computer (10) will provide an unlock control command to the microprocessor (211) of a specific main controller (21) if the vehicle driver has lost a ticket.

The identification device (212) is connected to the microprocessor (211) to obtain the identification of the driver of the vehicle parked in the parking space (31). The identification device (212) will store the driver's identification or output the driver's identification to the microprocessor (211). The identification device (212) can be a card reader (212a), a fingerprint identifier (212b), keyboard (212c), a lock with a key (212d), or a ticket printer (212e) and reader (212f).

The display device (213) is connected to the outputs of the microprocessor (211) to display parking time or other related parking information. The alarm (214) is connected to the output of the microprocessor (211) to signal the vehicle driver.

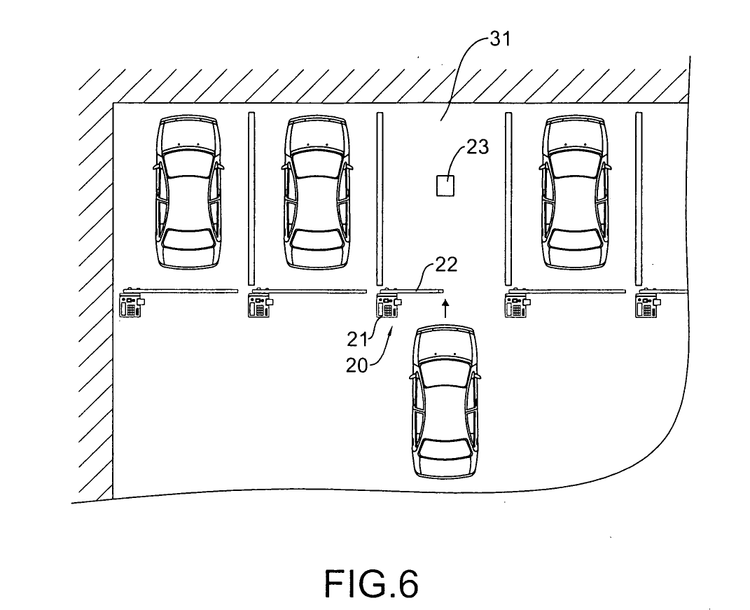

With further reference to FIG. 6, the sensor (23) can be set in a specific position in the parking space (31) to detect when a vehicle enters the parking space (31). The sensor (23) is connected to the input of the microprocessor (211) so the sensor can output the detecting signal to the microprocessor (211).

When the microprocessor (211) detects a car parked in the parking space (31) through the sensor (23), the microprocessor (211) closes the electrical gate (22) and starts to count parking time. A driver has to go to the main controller (21) to leave his or her identification using the identification device (212). When the driver would like to drive vehicle out of the parking space (31), the driver has to provide his or her identification to the identification device (212). After obtaining the driver's identification, the identification device (212) outputs the driver's identification to the microprocessor (211) to check whether the present identification given matches the previously stored one. If the check result is correct, the microprocessor (211) performs the parking fee charging and collection procedure according to the counted parking time. When the parking fee charging and collection procedure is ended successfully, the microprocessor (21 1) controls the electrical gate (22) to open.

The card reader (212a), the microprocessor (211) and the host computer (10) can be linked to a bank server through a special network line to implement the parking fee charging and collection procedure. The driver can use a credit card to pay the parking fee since the host computer (10) is linked to the bank server. In addition, the driver can also use the credit card and the card reader (212a) of the main controller (21) to leave the credit card number in the main controller (21). When driver would like to drive the vehicle to leave the parking space (31), the driver can use the same credit card to check the identification and pay the parking fee at the same time.

If the identification device (212) uses the fingerprint identifier (212b), the driver puts a finger in the fingerprint identifier to store the fingerprint to be used to identify the driver. If the keyboard (212c) is used as the identification device (2.12), the driver can enter a password to be used as the driver's identification. If the lock with the key (212d) is used as the identification device, the key (212d) is the driver's identification. When the vehicle has been parked in the parking space, the driver can remove the key from the lock (212d). When the driver would like to drive the vehicle away, the driver only needs to insert the key into the lock (212d) to complete the driver identification procedure. If the ticket printer (212e) and reader (212f) are used as the identification device, the driver takes the ticket from the ticket printer (212e) after parking the vehicle in the parking space (31) and the ticket is used as the driver's identification. Before the driver drives the vehicle away, the driver puts the ticket in the ticket reader to check the correctness of the ticket.

The host computer (10) will collect the related parking information from each gate controller (20) periodically and the system can easily manage the parking situation in the entire vehicle parking area (30). Furthermore, if a driver has lost his/her credit card, the password, the key, or the ticket, the main computer (10) will output a unlock control command to make the specific gate controller of the corresponding parking space (31) open the electrical gate (22).

The present invention sets multiple gate controllers in corresponding parking spaces and uses one host computer to manage the gate controllers. Each vehicle driver can finish taking a ticket, checking identification, and paying the parking fee in his or her own parking space. Therefore, the vehicle parking system can solve the traffic jam problem during busy times and increase the vehicle handling capacity.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A vehicle parking system, performed in a vehicle parking area having multiple parking spaces, comprising:
at least one host computer; and
multiple gate controllers set respectively at an entrance of a corresponding parking space and connected to the host computer, wherein each gate controller has an auto-restraining and parking fee charging and collection capability.

2. The vehicle parking system as claimed in claim 1, wherein each gate controller comprises
a controller comprising
a microprocessor linked to the host computer by dual communication methods;
an identification device connected to the microprocessor to obtain a driver's identification; and
a gate driver connected to the microprocessor;
an electrical gate connected to the gate driver of the controller, wherein the microprocessor controls operation of the electrical gate through the gate driver; and
a sensor connected to the microprocessor to detect whether a vehicle is in parking space or not.

3. The vehicle parking system as claimed in claim 2, further comprising a display device connected to the microprocessor.

4. The vehicle parking system as claimed in claim 2, further comprising an alarm device connected to the microprocessor.

5. The vehicle parking system as claimed in claim 1, wherein the identification device is a card reader.

6. The vehicle parking system as claimed in claim 1, wherein the identification device is a fingerprint identifier.

7. The vehicle parking system as claimed in claim 1, wherein the identification device is a keyboard.

8. The vehicle parking system as claimed in claim 1, wherein the identification device is a lock with a key.

9. The vehicle parking system as claimed in claim. 1, wherein the identification device is a ticket printer and reader.

10. A gate controller of the vehicle parking system, comprising:
a controller comprising
a microprocessor linked to the host computer by dual communication ways;
an identification device connected to the microprocessor to obtain a driver's identification; and
a gate driver connected to the microprocessor;
an electrical gate connected to the gate driver of the controller, wherein the microprocessor controls operation of the electrical gate through the gate driver; and
a sensor connected to the microprocessor to detect whether a vehicle is in parking space or not.

11. The gate controller as claimed in claim 10, further comprising a display device connected to the microprocessor.

12. The gate controller as claimed in claim 10, further comprising an alarm device connected to the microprocessor.

13. The gate controller as claimed in claim 10, wherein the identification device is a card reader.

14. The gate controller as claimed in claim 10, wherein the identification device is a fingerprint identifier.

15. The gate controller as claimed in claim 10, wherein the identification device is a keyboard.

16. The gate controller as claimed in claim 10, wherein the identification device is a lock with a key.

17. The gate controller as claimed in claim 10, wherein the identification device is a ticket printer and reader.
